(19) United States
(12) Patent Application Publication
(10) Pub. No.: US 2025/0356021 A1
(43) Pub. Date: Nov. 20, 2025

(54) ELECTRONIC APPARATUS

(71) Applicant: KYOCERA Document Solutions Inc., Osaka (JP)

(72) Inventors: Daichi Iida, Osaka (JP); Masato Shiose, Osaka (JP); Koji Kuroda, Osaka (JP)

(21) Appl. No.: 19/205,855

(22) Filed: May 12, 2025

(30) Foreign Application Priority Data
May 20, 2024 (JP) 2024-082128

(51) Int. Cl. G06F 21/57

(52) U.S. Cl. CPC G06F 21/575; G06F 21/577; G06F 2221/033

(57) ABSTRACT

An electronic apparatus includes a non-volatile memory device, a falsification detecting unit, and a bootcode rewriting unit. The non-volatile memory device includes a first memory area and a second memory area. The falsification detecting unit is configured to read a bootcode from the first memory area and determine whether the read bootcode is falsified or not. The bootcode rewriting unit is configured to rewrite a bootcode in the second memory area with the bootcode in the first memory area if it is determined that the read bootcode is not falsified and the bootcode in the first memory area and the bootcode in the second bootcode are not identical to each other.

### CROSS-REFERENCE TO RELATED APPLICATIONS

This application relates to and claims priority rights from Japanese Patent Application No. 2024-082128, filed on May 20, 2024, the entire disclosures of which are hereby incorporated by reference herein.

### BACKGROUND

### 1. Field of the Present Disclosure

The present disclosure relates to an electronic apparatus.

### 2. Description of the Related Art

When falsification of bootdata is detected in an information processing apparatus, the information processing apparatus changes the bootdata to a status before the falsification of the bootdata is detected.

However, in the aforementioned information processing apparatus, when falsification of bootdata is detected, the boot data may be changed to a vulnerable status and it is not favorable for its information security.

### SUMMARY

An electronic apparatus according to an aspect of the present disclosure includes a non-volatile memory device, a falsification detecting unit, and a bootcode rewriting unit. The non-volatile memory device includes a first memory area and a second memory area. The falsification detecting unit is configured to read a bootcode from the first memory area and determine whether the read bootcode is falsified or not. The bootcode rewriting unit is configured to rewrite a bootcode in the second memory area with the bootcode in the first memory area if it is determined that the read bootcode is not falsified and the bootcode in the first memory area and the bootcode in the second bootcode are not identical to each other.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an electronic apparatus according to an embodiment of the present disclosure; and

FIG. 2 shows a flowchart that explains a behavior of the electronic apparatus shown in FIG. 1.

### DETAILED DESCRIPTION

Hereinafter, an embodiment according to an aspect of the present disclosure will be explained with reference to drawings.

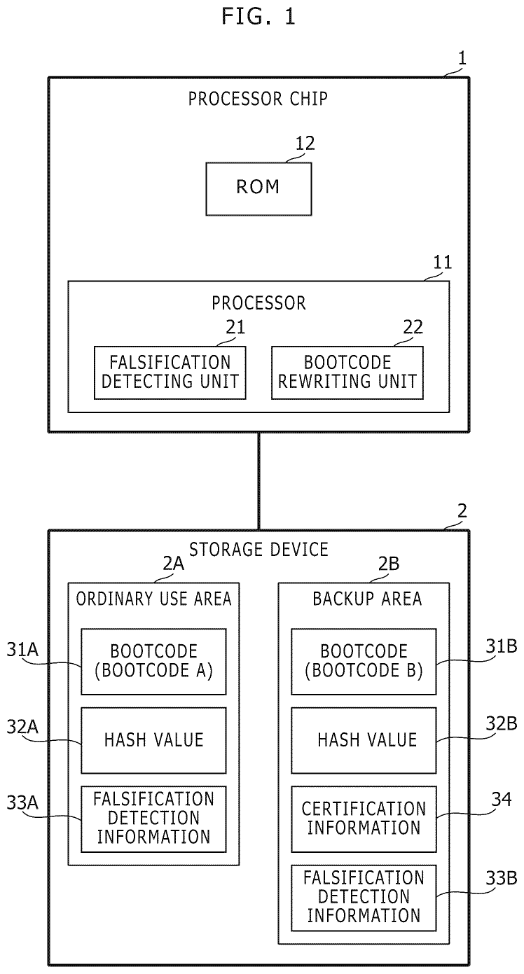

FIG. 1 shows block diagram that indicates a configuration of an electronic apparatus according to an embodiment of the present disclosure. The electronic apparatus shown in FIG. 1 includes a processor chip 1, and a rewritable non-volatile memory device 2 such as flash memory. The processor chip 1 performs a read operation and a write operation to the memory device 2.

The processor chip 1 includes a processor 11 such as CPU (Central Processing Unit) and a ROM (Read Only Memory) 12.

The processor 11 executes a program (boot loader, boot program, application program or the like) stored in the ROM 12 or the memory device 2 and thereby performs sorts of processes. In particular, the processor 11 loads a program such as boot loader from the ROM 12 when powering on and executes the program, and thereby acts as a falsification detecting unit 21 and a bootcode rewriting unit 22.

Further, in the memory device 2, an ordinary usage area 2A (first memory area) and a backup area (second memory area) are allocated as memory areas.

In the ordinary usage area 2A, a bootcode 31A, a hash value 32A of the bootcode 31A, and falsification detection information 33A are stored. The falsification detection information 33A is a (single) hash value of both the bootcode 31A and the hash value 32A.

In the backup area 2B, a bootcode 31B, a hash value 32B of the bootcode 31B, certification information 34, and falsification detection information 33B stored. The falsification detection information 33B is a (single) hash value of all the bootcode 31B, the hash value 32B, and the certification information 34.

The bootcode 31B and the hash value 32B in the backup area 2B are the bootcode 31A and the hash value 32A read from the ordinary usage area 2A and written to the backup area 2B.

The certification information 34 is data that has a value unique to this electronic apparatus (the processor chip 1).

Further, the falsification detecting unit 21 reads the bootcode 31A in the ordinary usage area 2A and determines whether the read bootcode 31A is falsified or not. Specifically, the falsification detecting unit 21 reads not only the bootcode 31A but the hash value 32A and the falsification detection information 33A, derives a hash value of both the read bootcode 31A and the hash value 32A, and determines whether the derived hash value and the falsification detection information 33A are identical to each other or not; and if the both are identical to each other, the falsification detecting unit 21 determines that the bootcode 31A is not falsified and if the both are not identical to each other, the falsification detecting unit 21 determines that the bootcode 31A is falsified. Here, “falsification” includes not only a case that it has been intentionally changed but unintended data damage or the like.

Similarly, if it is determined that the bootcode 31A read from the ordinary usage area 2A is falsified, the falsification detecting unit 21 reads the bootcode 31B from the backup area 2B, and determines whether the bootcode 31B read from the backup area 2B is falsified or not on the basis of the falsification detection information 33B.

Further, if it is determined that the bootcode 31A read from the ordinary usage area 2A is not falsified and the bootcode 31A in the ordinary usage area 2A and the bootcode 31B in the backup area 2B are not identical to each other, then the bootcode rewriting unit 22 rewrites the bootcode 31B in the backup area 2B with the bootcode 31A in the ordinary usage area 2A.

Thus, every time that this electronic apparatus starts, if the bootcode 31A is not falsified, then the bootcode 31B is caused to be identical to the bootcode 31A.

If it is determined that the bootcode 31A read from the ordinary usage area 2A is falsified and it is determined that the bootcode 31B read from the backup area 2B is not falsified, then the bootcode rewriting unit 22 acquires a newest bootcode from an external server or the like, and rewrites the bootcode 31A in the ordinary usage area 2A with the acquired bootcode.

Further, in this embodiment, if it is determined that the bootcode 31B read from the backup area 2B is not falsified, the bootcode rewriting unit 22 acquires the newest bootcode and a hash value of the newest bootcode and rewrites the bootcode 31A and the hash value 32A in the ordinary usage area 2A with the acquired newest bootcode and the acquired hash value of the newest bootcode; and if it is determined that the bootcode 31A read from the ordinary usage area 2A is not falsified and the bootcode 31A in the ordinary usage area 2A and the bootcode 31B in the backup area 2B are not identical to each other, the bootcode rewriting unit 22 rewrites the bootcode 31B and the hash value 32B in the backup area 2B with the bootcode 31A and the hash value 32A in the backup area 2A.

Further, the falsification detecting unit 21 (a) acquires a hash value of both the bootcode 31A and the hash value 32A in the ordinary usage area 2A and writes the acquired hash value as falsification detection information 33A into the ordinary usage area 2A and determines whether the bootcode 31A read from the ordinary usage area 2A is falsified or not on the basis of the falsification detection information, and (b) determines whether the bootcode 31B read from the backup area 2B is falsified or not on the basis of falsification detection information in the backup area 2B.

Further, when the bootcode rewriting unit 21 rewrites the bootcode 31B and the hash value 32B in the backup area 2B with the bootcode 31A and the hash value 32A in the ordinary usage area 2A, the falsification detecting unit 21 generates certification information 34 unique to this electronic apparatus and stores the certification information 34 into the backup area 2B, and writes as the falsification detection information to the backup area 2B a hash value of all the bootcode 31B, the hash value 32B and the certification information 34 in the backup area 2B. Furthermore, when the falsification detecting unit 21 reads the bootcode 31B from the backup area 2B, the falsification detecting unit 21 also reads the falsification detection information 33B and the certification information 34 from the backup area 2B, and determines whether the bootcode 31B read from the backup area 2B is falsified or not on the basis of the read falsification detection information 33B; and if the read certification information 34 is different from the certification information 34 when it was generated, the falsification detecting unit 21 determines that the memory device 2 has been replaced fraudulently and stops a starting process performed in accordance with the bootcode 31A or 31B.

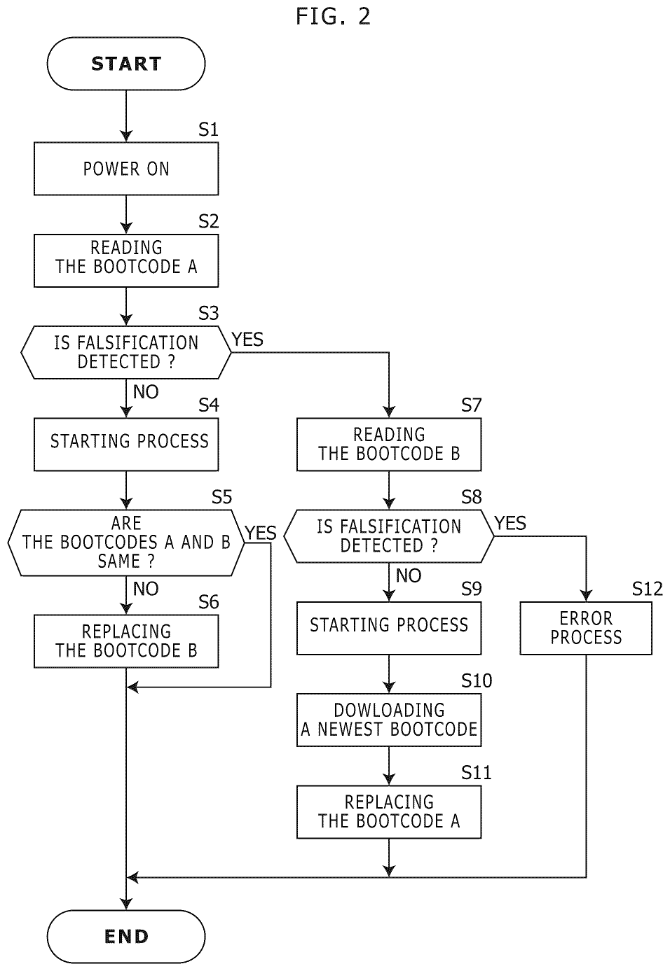

The following part explains the aforementioned electronic apparatus. FIG. 2 shows a flowchart that explains a behavior of the electronic apparatus shown in FIG. 1.

When this electronic apparatus is powered on (in Step S1), the falsification detecting unit 21 reads the bootcode 31A and the like from the ordinary usage area 2A (in Step S2), and determines whether the bootcode 31A is falsified or not (in Step S3).

If it is determined that the bootcode 31A is not falsified, a predetermined starting process is performed in accordance with the bootcode 31A (in Step S4). Subsequently, the bootcode rewriting unit 22 determines whether the bootcode 31A and the bootcode 31B in the backup area 2B are identical to each other or not (in Step S5); and if the both are not identical to each other, the bootcode rewriting unit 22 rewrites the bootcode 31B in the backup 2B with the bootcode 31A (in Step S6).

Contrarily, in Step S3 if it is determined that the bootcode 31A is falsified, the falsification detecting unit 21 reads the bootcode 31b and the like in the backup area 2b (in Step S7), and determines whether the bootcode 31B is falsified or not (in Step S8).

If it is determined that the bootcode 31B is not falsified, a predetermined starting process is performed in accordance with the bootcode 31B (in Step S9). Subsequently, the bootcode rewriting unit 22 downloads a newest bootcode (in Step S10), and rewrites the bootcode 31A in the ordinary usage area 2A with the downloaded bootcode (in Step S11).

Meanwhile, in Step S8 if it is determined that the bootcode 31B is falsified, an error process is performed and the starting process of this electronic apparatus is stopped (in Step S12).

As mentioned, in the aforementioned embodiment, the memory device 2 is a non-volatile memory device that includes the ordinary usage area 2A and the backup area 2B. The falsification detecting unit 21 reads the bootcode 31A in the ordinary usage area 2A and determines whether the read bootcode 31A is falsified or not. If it is determined that the bootcode 31A read from the ordinary usage area 2A is not falsified and the bootcode 31A in the ordinary usage area 2A and the bootcode 31B in the backup area 2B are not identical to each other, then the bootcode rewriting unit 22 rewrites the bootcode 31B in the backup area 2B with the bootcode 31A in the ordinary usage area 2A.

Consequently, every time that this electronic apparatus starts, if the bootcode 31A is not falsified, the bootcode 31B is caused to be identical to the boot code 31A, and therefore, even if the bootcode 31B is used instead of the bootcode 31A when the bootcode 31A is falsified, the bootcode 31B that is identical to the bootcode 31A is used. Therefore, restrained is lowering information security due to a recovery process performed when falsification of the bootcode is detected.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, another processor than the processor that executes the bootcode 31A or 31B may act as the falsification detecting unit 21 and the bootcode rewriting unit 22.

Further, in the aforementioned embodiment, when it is determined whether the bootcodes 31A and 31B are identical to each other or not, it may be determined whether the hash values 32A and 32B are identical to each other or not, or hash values of the bootcodes 31A and 31B may be derived and it may be determined whether the respectively derived hash values are identical to each other.

What is claimed is:

1. An electronic apparatus, comprising:
a non-volatile memory device that comprises a first memory area and a second memory area;
a falsification detecting unit configured to read a bootcode from the first memory area and determine whether the read bootcode is falsified or not; and
a bootcode rewriting unit configured to rewrite a bootcode in the second memory area with the bootcode in the first memory area if it is determined that the read bootcode is not falsified and the bootcode in the first memory area and the bootcode in the second bootcode are not identical to each other.

2. The electronic apparatus according to claim 1, wherein if it is determined that the bootcode read from the first memory area is falsified, the falsification detecting unit reads the bootcode in the second memory area and determines whether the bootcode read from the second memory area is falsified or not; and
if it is determined that the bootcode read from the second memory area is not falsified, the bootcode rewriting unit acquires a newest bootcode and rewrites the bootcode in the first memory area with the acquired bootcode.

3. The electronic apparatus according to claim 2, wherein if it is determined that the bootcode read from the second memory area is not falsified, the bootcode rewriting unit acquires the newest bootcode and a hash value of the newest bootcode and rewrites the bootcode and a hash value in the first memory area with the newest bootcode and the hash value of the newest bootcode;
if it is determined that the bootcode read from the first memory area is not falsified and the bootcode in the first memory area and the bootcode in the second memory area are not identical to each other, the bootcode rewriting unit rewrites the bootcode and the hash value in the second memory area with the bootcode and the hash value in the first memory area; and
the falsification detecting unit (a) acquires a hash value of both the bootcode and the hash value of the bootcode in the first memory area and writes the acquired hash value as falsification detection information into the first memory area and determines whether the bootcode read from the first memory area is falsified or not on the basis of the falsification detection information, and (b) determines whether the bootcode read from the second memory area is falsified or not on the basis of falsification detection information in the second memory area.

4. The electronic apparatus according to claim 3, wherein when the bootcode rewriting unit rewrites the bootcode and the hash value in the second memory area with the bootcode and the hash value in the first memory area, the falsification detecting unit generates certification information unique to this electronic apparatus and stores the certification information into the second memory area, and writes as the falsification detection information to the second memory area a hash value of all the bootcode, the hash value of the bootcode and the certification information in the second memory area; and
when the falsification detecting unit reads the bootcode from the second memory area, the falsification detecting unit also reads the falsification detection information and the certification information from the second memory area, and determines whether the bootcode read from the second memory area is falsified or not on the basis of the read falsification detection information, and if the read certification information is different from the generated certification information, the falsification detecting unit determines that the memory device has been replaced fraudulently and stops a starting process performed in accordance with the bootcode.
